(19) United States
(12) Patent Application Publication
(10) Pub. No.: US 2024/0154322 A1
(43) Pub. Date: May 9, 2024

(54) BEAM STEERING ARRANGEMENT FOR ELECTRONIC APPARATUS

(71) Applicants: Janne ILVONEN, Kista (SE); HUAWEI TECHNOLOGIES CO., LTD., Shenzhen, Guangdong (CN)

(72) Inventors: Janne ILVONEN, Helsinki (FI); Alexander KHRIPKOV, Helsinki (FI); Dong LIU, Dongguan (CN); Timofey KAMYSHEV, Helsinki (FI); Ruiyuan TIAN, Helsinki (FI); Zlatoljub MILOSAVLJEVIC, Helsinki (FI)

(21) Appl. No.: 18/552,418

(22) PCT Filed: Mar. 26, 2021
(86) PCT No.: PCT/EP2021/057993

§ 371 Date: Sep. 25, 2023

(51) Int. Cl. H01Q 21/06; H01Q 1/24; H01Q 15/14

(52) U.S. Cl. CPC H01Q 21/067; H01Q 1/243; H01Q 15/14

(57) ABSTRACT

An example radiation field beam steering arrangement includes a substrate having a reflector surface, a conductive element extending at least partially adjacent a periphery of the substrate, and at least one end-fire antenna element superimposed with the substrate and comprising an antenna radiator. The reflector surface comprises a plurality of reflectors, each reflector having a hollow profile and is configured to reflect at least a part of a radiation field generated by the antenna radiator that is towards a main beam direction oriented parallel to a main plane of the substrate.

### CROSS-REFERENCE TO RELATED APPLICATIONS

This application is a National Stage of International Patent Application No. PCT/EP2021/057993, filed on Mar. 26, 2021, which is hereby incorporated by reference in its entirety.

### TECHNICAL FIELD

The disclosure relates to a radiation field beam steering arrangement comprising a reflector and at least one end-fire antenna element.

### BACKGROUND

Mobile apparatuses such as smartphones require omni-coverage dual-polarized mmWave antennas to achieve stable communication in all directions and orientations. However, requirements on the design include the apparatus having a curved design with a sleek metal frame and a large display, with very small clearance therebetween. The frame should preferably not have any visible openings. These requirements are contradictory and thus difficult to achieve in one and the same apparatus.

In one known solution, having a moderately curved display, the end-fire antenna module is positioned towards the dielectric back cover of the apparatus, such that the metal frame of the apparatus does not shadow the antenna. This necessarily limits the battery size, with regards to battery thickness and the required placement of the antenna module. This design provides fairly good end-fire performance, however, the directivity of the antenna is tilted by approximately 30 degrees towards the back cover. Furthermore, the space between the back cover and the display has to be increased when to accommodate the antenna module.

In a further known solution, a more challenging design is provided using a highly curved display. The symmetric glass curvature forces the antenna module to be arranged closer towards the display, which causes the metal frame to shadow the antenna. Furthermore, the antenna has to be arranged closer to the frame in order to allow a sufficiently large battery to be used. Since the antenna is arranged relatively close to the edge, the end-fire directivity would be tilted by up to almost 90 deg and have a wide beam angle.

Hence, there is a need for a solution which provides good end-fire performance and directivity for apparatuses having metal frames and curved displays.

### SUMMARY

It is an object to provide an improved beam steering arrangement for a handheld device. The foregoing and other objects are achieved by the features of the independent claims. Further implementation forms are apparent from the dependent claims, the description, and the figures.

According to a first aspect, there is provided a radiation field beam steering arrangement comprising a substrate comprising a reflector surface, a conductive element extending at least partially adjacent a periphery of the substrate, and at least one end-fire antenna element superimposed with the substrate and comprising an antenna radiator configured generate a radiation field having a main beam direction oriented parallel to a main plane of the substrate. The reflector surface comprises plurality of reflectors, each reflector having a hollow profile and being configured to reflect at least a part of the generated radiation field towards the main beam direction.

Such a beam steering arrangement provides a radiation field which is highly efficient and which does not require tilting of the directivity of the end-fire antenna element even though the end-fire antenna element is arranged relatively close to a conductive element such as a metal frame, such conductive elements usually shadowing adjacent antenna elements. Since the directivity of the end-fire antenna element does not need to be tilted towards the back cover of the apparatus, the omni-coverage of the antenna element is improved. Furthermore, the beam steering arrangement can be used together with highly curved display elements, since the reflectors allows correct beam steering regardless of the small distances involved.

In a possible implementation form of the first aspect, the hollow profile is one of an elliptical, rectangular, or circular hollow profile, the hollow profile extending in a first direction perpendicular to a main plane of the antenna radiator and in a second direction parallel with the main plane of the antenna radiator, enabling a very compact reflector surface which can be made invisible to the user of an apparatus.

In a further possible implementation form of the first aspect, the reflector comprises an exterior rim enclosing an interior hollow, improving the realized gain for one first polarization while not degrading the realized gain for the other polarization.

In a further possible implementation form of the first aspect, a center axis of the hollow profile extends in a direction perpendicular to a main plane of the reflector surface, allowing at least a part of the generated radiation field to be reflected towards the main beam direction.

In a further possible implementation form of the first aspect, the reflector surface is arranged within a near-field region of the antenna element, such that antenna performance is sufficient while still providing a very compact beam steering arrangement.

In a further possible implementation form of the first aspect, the antenna element is arranged at a first distance, along the main beam direction, from the conductive element, and the reflector surface is arranged at a second distance, along the main beam direction, from the conductive element, the second distance being the same as or larger than the first distance. By arranging the reflective surface away from the antenna element, increased design freedom may be enabled without deteriorating antenna performance.

In a further possible implementation form of the first aspect, the reflector surface extends adjacent the antenna radiator such that a dielectric gap is formed between a peripheral edge of the reflector surface and the antenna radiator in the first direction, the dielectric gap being formed in the near-field region, allowing the reflected radiation field to propagate uninterruptedly within the arrangement towards the main beam direction.

In a further possible implementation form of the first aspect, the reflector surface at least partially overlaps the antenna radiator in the first direction, increasing design freedom without deteriorating antenna performance.

In a further possible implementation form of the first aspect, the conductive element is separated from the periphery of the substrate by a dielectric gap, allowing the reflected radiation field to propagate uninterruptedly between components towards the main beam direction.

In a further possible implementation form of the first aspect, the reflector surface comprises individual surface(s) arranged separately at a distance from the antenna element(s), increasing design freedom without deteriorating antenna performance.

In a further possible implementation form of the first aspect, at least two of the plurality of reflectors are arranged to form an array of reflectors extending in the second direction, improving antenna peak directivity.

In a further possible implementation form of the first aspect, at least one reflector is aligned with each antenna radiator in the first direction and in the second direction, ensuring radiation reflection for each antenna element.

In a further possible implementation form of the first aspect, at least one of the reflectors has a dimension which at least corresponds to λ/2, λ being a wavelength of the radiation. This assures the end-fire radiation direction and helps avoid parasitic resonance.

In a further possible implementation form of the first aspect, the dimension extends in the second direction.

In a further possible implementation form of the first aspect, the reflector surface comprises at least one first reflector and at least one second reflector aligned with each antenna radiator and separated by a dielectric gap in the first direction, the first reflector being arranged between the antenna radiator and the second reflector. The size of the dielectric gap can be adapted to the individual configuration of the apparatus and to the manufacturing technology used.

In a further possible implementation form of the first aspect, the first reflector has a different dimension in the second direction, and/or a different shape, than the second reflector, allowing the reflectors to be configured such that the end-fire gain for one polarization is enhanced without deteriorating the end-fire gain for the other polarization. The difference in dimensions broadens the reflected frequency range and improves broadband performance.

In a further possible implementation form of the first aspect, the reflector surface extends at least partially at a 90° angle to the main plane of the antenna radiator, allowing the reflector surface to be directly applied onto, and follow, the surface of the substrate.

In a further possible implementation form of the first aspect, the radiation field beam steering arrangement further comprises conductors configured to operatively connect the reflector surface to the antenna element(s).

In a further possible implementation form of the first aspect, the reflector surface reflects the radiation in a radiation pattern having a first polarization, the first polarization extending in a plane comprising the main end-fire radiation direction.

In a further possible implementation form of the first aspect, the first polarization being a horizontal polarization.

In a further possible implementation form of the first aspect, the substrate has a curvature, the reflector surface at least partially having a corresponding curvature, allowing the reflector surface to be used also for curved substrates such as curved displays.

In a further possible implementation form of the first aspect, the reflector surface is placed onto a surface of the substrate, and comprises a conductive ink or a conductive mesh applied directly onto the surface or onto a film applied onto the surface. This allows for a simple and small solution which requires few additional components.

In a further possible implementation form of the first aspect, the conductive mesh comprises a resistive web having strips which are invisible to the naked eye.

In a further possible implementation form of the first aspect, the substrate encloses the reflector surface, the substrate being a multi-layer structure and the reflector surface forming one layer of the multi-layer structure, providing a substrate such as a display with integrated beam steering functionality.

According to a second aspect, there is provided an apparatus comprising a display element, a back cover, and the radiation field beam steering arrangement according to the above, the substrate of the radiation field beam steering arrangement being one of the back cover and a flexible printed circuit, the conductive element of the radiation field beam steering arrangement being arranged at least partially between the display element and the back cover, and the antenna radiator(s) of the radiation field beam steering arrangement extending adjacent the conductive element.

Such an apparatus comprises an antenna and beam steering arrangement which has a highly efficient radiation field with omni-coverage. The end-fire antenna elements can be arranged relatively close to the conductive element of the apparatus, freeing up space within the apparatus for, e.g., the battery. Furthermore, the beam steering arrangement can be used together with highly curved display elements, since the reflectors allows correct beam steering regardless of the small distances involved.

In a possible implementation form of the second aspect, the back cover is made of a dielectric material, preferably glass or plastic, allowing radiation to propagate uninhibitedly through the back cover, such as radiation emitted by the above-mentioned one end-fire antenna elements as well as radiation emitted by additional broad-fire antenna elements.

In a further possible implementation form of the second aspect, the flexible printed circuit extends adjacent the back cover, increasing the flexibility of the beam steering arrangement while still taking up as little space as possible within the apparatus.

These and other aspects will be apparent from the embodiment(s) described below.

### BRIEF DESCRIPTION OF THE DRAWINGS

In the following detailed portion of the present disclosure, the aspects, embodiments, and implementations will be explained in more detail with reference to the example embodiments shown in the drawings, in which:

FIG. 1 shows a partial perspective view of a radiation field beam steering arrangement in accordance with an example of the embodiments of the disclosure;

FIG. 2 shows a cross-sectional view of an apparatus comprising a radiation field beam steering arrangement in accordance with an example of the embodiments of the disclosure;

FIG. 3 shows a cross-sectional view of an apparatus comprising a radiation field beam steering arrangement in accordance with an example of the embodiments of the disclosure;

FIG. 4 shows a cross-sectional view of an apparatus comprising a radiation field beam steering arrangement in accordance with an example of the embodiments of the disclosure, indicating a radiation field beam;

FIG. 5a shows a cross-sectional view of an apparatus in accordance with prior art, indicating the directionality of the radiation field beam;

FIG. 5b shows a cross-sectional view of an apparatus in accordance with prior art comprising a radiation field beam steering arrangement in accordance with an example of the embodiments of the disclosure, indicating the directionality of the radiation field beam;

FIG. 6 shows a partial top view of a radiation field beam steering arrangement in accordance with an example of the embodiments of the disclosure;

FIGS. 7a to 7c show top views of reflector surfaces of radiation field beam steering arrangements in accordance with examples of the embodiments of the disclosure.

### DETAILED DESCRIPTION

FIG. 2 shows an apparatus 6, preferably a handheld device such as a smartphone or a tablet, comprising a display element 7, a back cover 8, and a radiation field beam steering arrangement 1 described in more detail below.

One of the back cover 8 and a flexible printed circuit (not shown) of the apparatus 6 comprises the substrate 2 of the radiation field beam steering arrangement 1, as shown in FIGS. 2, 3, and 4. The flexible printed circuit is enclosed by the back cover 8, the display element 7 and a conductive element 9, such as a metal frame. The flexible printed circuit may extend adjacent the back cover 8, however the flexible printed circuit may be arranged at any suitable location within the apparatus 6.

The back cover 8 may be made of a dielectric material, preferably glass or plastic.

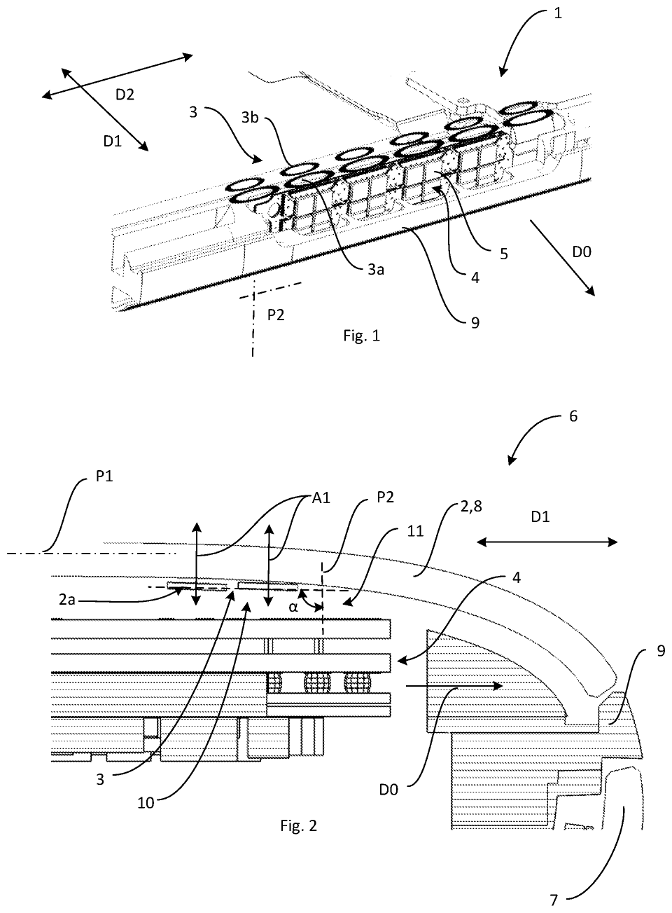

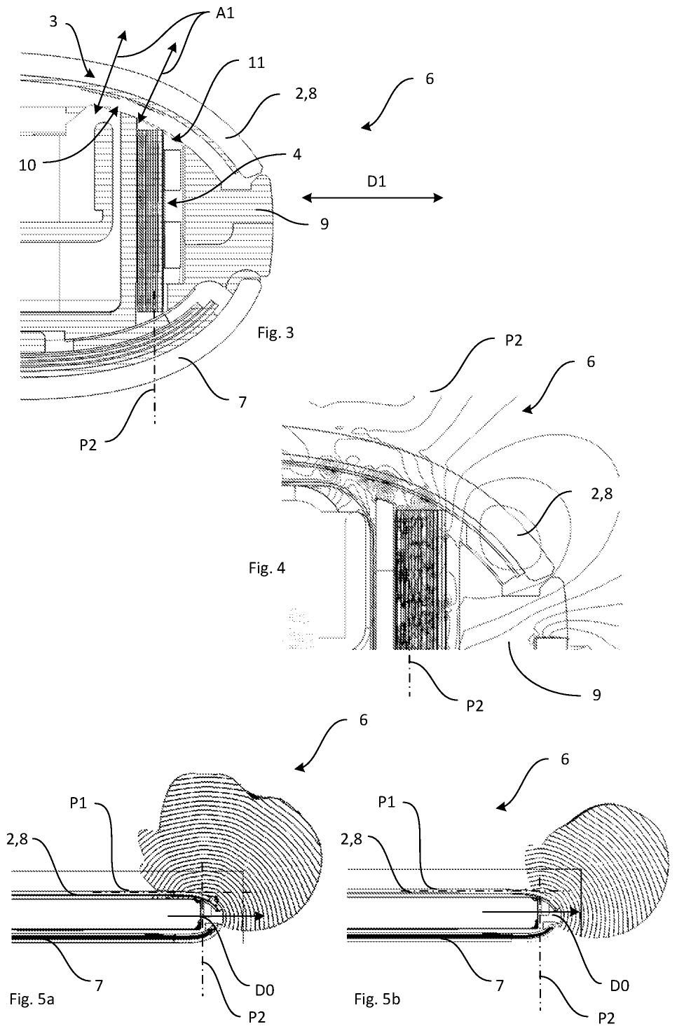

The conductive element 9 of the radiation field beam steering arrangement 1 is arranged at least partially between the display element 7 and the back cover 8, as shown in FIGS. 2 and 3. The antenna radiators 5 of the radiation field beam steering arrangement 1 extend adjacent the conductive element 9, as shown in FIG. 1.

FIGS. 1 and 2 show the radiation field beam steering arrangement 1 mentioned above. The radiation field beam steering arrangement 1 comprises the substrate 2, which substrate 2 comprises a reflector surface 3, the conductive element 9 which extends at least partially adjacent a periphery of the substrate 2, and at least one end-fire antenna element 4 superimposed with the substrate 2 and comprising an antenna radiator 5 configured generate a radiation field having a main beam direction DO oriented parallel to a main plane P1 of the substrate 2, the reflector surface 3 comprising plurality of reflectors 3a, 3b, each reflector 3a, 3b having a hollow profile and being configured to reflect at least a part of the generated radiation field towards the main beam direction D0.

As already mentioned, the radiation field beam steering arrangement 1 comprises a substrate 2, and the substrate 2 in turn comprises a reflector surface 3. The substrate 2 may have a curvature, and the reflector surface 3 may at least partially have a corresponding curvature. The reflector surface 3 may be placed onto a surface 2a of the substrate 2, such as a surface facing the flexible printed circuit. The reflector surface 3 may comprise a conductive ink, such as silver paint, or a conductive mesh applied directly onto the surface 2a or onto a film applied onto the surface 2a. The reflector surface 3 may be applied onto a decorative film such that it is invisible from the outside, should the back cover 8 be made of a see-through material. The conductive mesh may comprise a resistive web having strips which are invisible to the naked eye. Furthermore, the substrate 2 may enclose the reflector surface 3 (not shown), the substrate 2 being a multi-layer structure and the reflector surface 3 forming one layer of the multi-layer structure. The reflector surface 3 may also be applied onto the flexible printed circuit.

The conductive element 9 is arranged such that it extends at least partially adjacent a periphery of the substrate 2. The conductive element 9 may be separated from the periphery of the substrate 2 by a dielectric gap 10.

At least one end-fire antenna element 4 is superimposed with the substrate 2 and comprises an antenna radiator 5. The antenna radiator 5 is configured generate a radiation field having a main beam direction D0 oriented parallel to a main plane P1 of the substrate 2, as shown in FIGS. 1 and 5b. The antenna element 4 may be arranged at a first distance, along the main beam direction D0, from the conductive element 9. Correspondingly, the reflector surface 3 may be arranged at a second distance, along the main beam direction D0, from the conductive element 9. The second distance may be the same as or larger than the first distance. The first distance and the second distance may be adapted to the specific configuration of an individual apparatus, however, when moving the reflector surface 3 closer to the antenna element 4, the size of the dielectric gap is reduced and efficiency bandwidth at 24-26 GHz is limited. Preferably, the second distance is never smaller than the first distance such that the reflector surface 3 is not placed closer to the exterior of the apparatus than the antenna element 4. Furthermore, the reflector surface 3 should not be placed too close to the interior of the apparatus either, i.e. the difference between the first distance and the second distance should not be too large.

The beam steering arrangement 1 may furthermore comprise conductors configured to operatively connect the reflector surface 3 to the antenna elements 4 (not shown).

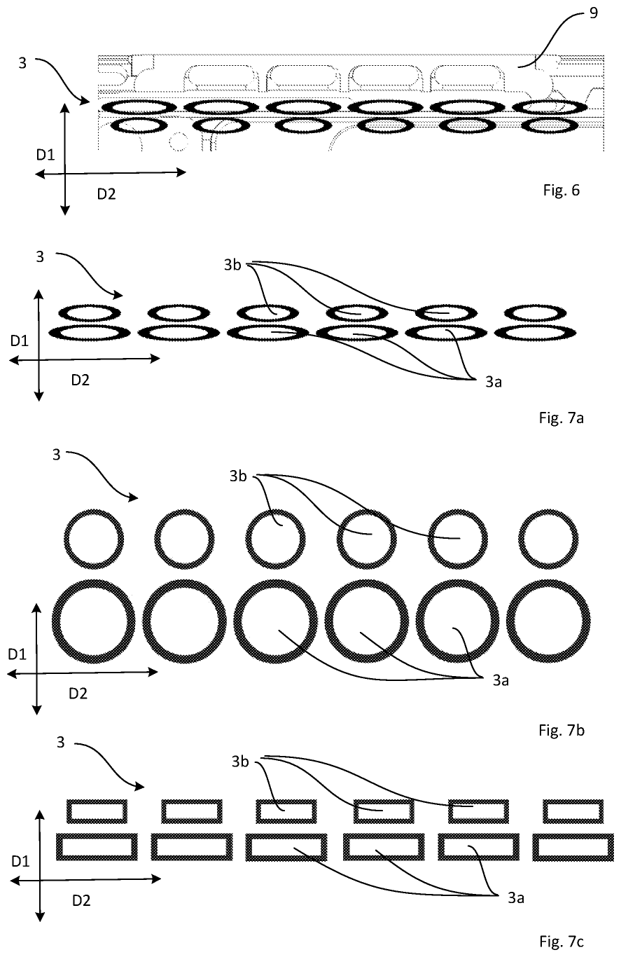

The reflector surface 3 may extend at least partially at a 90° angle α to the main plane P2 of the antenna radiator 5, as suggested in FIG. 2. The reflector surface 3 may comprise individual surfaces arranged separately at a distance from the antenna elements 4. The reflector surface 3 may comprise a plurality of reflectors 3a, 3b, as shown in FIGS. 7a to 7c. Each reflector 3a, 3b has a hollow profile and is configured to reflect at least a part of the generated radiation field towards the main beam direction D0. The reflector 3a, 3b may comprise an exterior rim enclosing an interior hollow. A center axis A1 of the hollow profile may extend in a direction perpendicular to a main plane of the reflector surface 3. The main plane of the reflector surface 3 may coincide with the main plane P1 of the substrate 2.

The hollow profile may be one of an elliptical hollow profile, as shown in FIGS. 6 and 7a, a rectangular hollow profile, as shown in FIG. 7c, and a circular hollow profile, as shown in FIG. 7b. Furthermore, several different hollow profiles may be combined within one reflector surface.

The hollow profile extends in a first direction D1 perpendicular to a main plane P2 of the antenna radiator 5 and in a second direction D2 parallel with the main plane P2 of the antenna radiator 5, as shown in FIGS. 1 and 6 to 7c. For an elliptical hollow profile, the outer dimensions are preferably larger in the second direction D2 than in the first direction D1.

The reflector surface 3 may be arranged within a near-field region of the end-fire antenna element 4, as shown in FIGS. 1 to 3. The reflector surface 3 may extend adjacent the antenna radiator 5 such that a dielectric gap 11 is formed between a peripheral edge of the reflector surface 3 and the antenna radiator in the first direction D1, the dielectric gap 11 being formed in the near-field region, as shown in FIGS. 2 and 3. The reflector surface 3 may at least partially overlap the antenna radiator 5 in the first direction D1, as shown in FIGS. 2 and 3.

At least two of the plurality of reflectors 3a, 3b may be arranged to form an array of reflectors 3a, 3b extending in the second direction D2, as shown in FIGS. 6 to 7c. At least one reflector 3a, 3b may be aligned with each antenna radiator 5 in the first direction D1 and in the second direction D2.

The reflector surface 3 may comprise at least one first reflector 3a and at least one second reflector 3b which are aligned with each antenna radiator 5 and separated by a dielectric gap in the first direction D1, the first reflector 3a being arranged between the antenna radiator 5 and the second reflector 3b. The dielectric gap may be 0.1-1 mm, preferably 0.1-0.2 mm wide.

A plurality of first reflectors 3a may form a first array, or row, of reflectors, and a plurality of second reflectors 3b may form a second array, or row, of reflectors. The first reflectors 3a are aligned with each other in the second direction D2, and correspondingly, the second reflectors 3b are aligned with each other in the second direction D2. Further rows of reflectors may extend in parallel with the first and second rows.

The first reflector 3a may have a different dimension in the second direction D2, and/or a different shape, than the second reflector 3b. At least one of the reflectors 3a, 3b may have a dimension which at least corresponds to λ/2, λ being a wavelength, for example, at the lowest frequency of the radiation. This dimension preferably extends in the second direction D2. By having reflectors 3a, 3b with different dimensions in the second direction D2, the reflected frequency range is broadened, and the broadband performance improved, since the different reflectors correspond to different wavelengths λ1, λ2 etc.

The reflector surface 3 is configured to reflect the radiation in a radiation pattern having a first polarization, the first polarization extending in a plane comprising the main end-fire radiation direction D1. The first polarization may be a horizontal polarization. In other words, the reflector surface 3 is configured to enable a radiation field having horizontal polarization. The reflector surface 3 may improve the directivity average of the radiation field by 2.7 dB, as well as increase the peak directivity. FIG. 5a shows a prior art solution without reflector surface, generating a wide radiation field at 26 GHz. FIG. 5b shows the present invention, generating a more focused radiation field also at 26 GHz.

The various aspects and implementations have been described in conjunction with various embodiments herein. However, other variations to the disclosed embodiments can be understood and effected by those skilled in the art in practicing the claimed subject-matter, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage.

The reference signs used in the claims shall not be construed as limiting the scope. Unless otherwise indicated, the drawings are intended to be read (e.g., cross-hatching, arrangement of parts, proportion, degree, etc.) together with the specification, and are to be considered a portion of the entire written description of this disclosure. As used in the description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

1.-15. (canceled)

16. A radiation field beam steering arrangement comprising:
a substrate comprising a reflector surface;
a conductive element extending at least partially adjacent a periphery of said substrate; and
at least one end-fire antenna element superimposed with said substrate and comprising an antenna radiator configured to generate a radiation field having a main beam direction oriented parallel to a main plane of the substrate,
said reflector surface comprising a plurality of reflectors, each reflector having a hollow profile and being configured to reflect at least a part of said generated radiation field towards said main beam direction.

17. The radiation field beam steering arrangement according to claim 16, wherein said hollow profile is one of an elliptical, rectangular, or circular hollow profile,
said hollow profile extending in a first direction perpendicular to a main plane of said antenna radiator and in a second direction parallel with said main plane of said antenna radiator.

18. The radiation field beam steering arrangement according to claim 16, wherein said reflector surface is arranged within a near-field region of said at least one end-fire antenna element.

19. The radiation field beam steering arrangement according to claim 16, wherein said at least one end-fire antenna element is arranged at a first distance, along said main beam direction, from said conductive element, and
said reflector surface is arranged at a second distance, along said main beam direction, from said conductive element,
said second distance being the same as or larger than said first distance.

20. The radiation field beam steering arrangement according to claim 18, wherein said reflector surface extends adjacent said antenna radiator such that a dielectric gap is formed between a peripheral edge of said reflector surface and said antenna radiator in a first direction, said dielectric gap being formed in said near-field region.

21. The radiation field beam steering arrangement according to claim 17, wherein said reflector surface at least partially overlaps said antenna radiator in said first direction.

22. The radiation field beam steering arrangement according to claim 17, wherein at least two of said plurality of reflectors are arranged to form an array of reflectors extending in said second direction.

23. The radiation field beam steering arrangement according to claim 17, wherein at least one reflector is aligned with each antenna radiator in said first direction and in said second direction.

24. The radiation field beam steering arrangement according to claim 16, wherein at least one of said reflectors has a dimension which at least corresponds to λ/2, λ being a wavelength of said radiation.

25. The radiation field beam steering arrangement according to claim 17, wherein said reflector surface comprises at least one first reflector and at least one second reflector aligned with each antenna radiator and separated by a dielectric gap in said first direction, said first reflector being arranged between said antenna radiator and said second reflector.

26. The radiation field beam steering arrangement according to claim 25, wherein at least one of:
said first reflector has a different dimension in said second direction; or
said first reflector has a different shape than said second reflector.

27. The radiation field beam steering arrangement according to claim 16, wherein said reflector surface reflects said radiation in a radiation pattern having a first polarization, said first polarization extending in a plane comprising said main beam direction.

28. The radiation field beam steering arrangement according to claim 16, wherein said reflector surface is placed onto a surface of said substrate, and
comprises a conductive ink or a conductive mesh applied directly onto said surface or onto a film applied onto said surface.

29. The radiation field beam steering arrangement according to claim 16, wherein said substrate encloses said reflector surface, said substrate being a multi-layer structure and said reflector surface forming one layer of said multi-layer structure.

30. An apparatus comprising a display element, a back cover, and a radiation field beam steering arrangement,
wherein said radiation field beam steering arrangement comprises:
a substrate comprising a reflector surface;
a conductive element extending at least partially adjacent a periphery of said substrate; and
at least one end-fire antenna element superimposed with said substrate and comprising an antenna radiator configured to generate a radiation field having a main beam direction oriented parallel to a main plane of the substrate,
said reflector surface comprising a plurality of reflectors, each reflector having a hollow profile and being configured to reflect at least a part of said generated radiation field towards said main beam direction,
wherein the substrate is one of said back cover and a flexible printed circuit,
the conductive element is arranged at least partially between said display element and said back cover, and
the antenna radiator extends adjacent said conductive element.

31. The apparatus according to claim 30, wherein said hollow profile is one of an elliptical, rectangular, or circular hollow profile,
said hollow profile extending in a first direction perpendicular to a main plane of said antenna radiator and in a second direction parallel with said main plane of said antenna radiator.

32. The apparatus according to claim 30, wherein said at least one end-fire antenna element is arranged at a first distance, along said main beam direction, from said conductive element, and
said reflector surface is arranged at a second distance, along said main beam direction, from said conductive element,
said second distance being the same as or larger than said first distance.

33. The apparatus according to claim 31, wherein said reflector surface at least partially overlaps said antenna radiator in said first direction.

34. The apparatus according to claim 31, wherein at least one reflector is aligned with each antenna radiator in said first direction and in said second direction.

35. The apparatus according to claim 31, wherein said reflector surface comprises at least one first reflector and at least one second reflector aligned with each antenna radiator and separated by a dielectric gap in said first direction, said first reflector being arranged between said antenna radiator and said second reflector.
